(19) United States
(12) Patent Application Publication
(10) Pub. No.: US 2005/0235008 A1
(43) Pub. Date: Oct. 20, 2005

(54) Apparatus and method for collateral recovery

(76) Inventors: Walt Camping, Phoenix, AZ (US); John Rhodes, Phoenix, AZ (US)

Correspondence Address: Mark F. Wright;Wright Law Group, PLLC, Suite 2, 7201 West Oakland, Chandler, AZ, 85226, US

(21) Appl. No.: 11/153,513

(22) Filed: Jun. 14, 2005

Related U.S. Application Data
(63) Continuation-in-part of application No. 10/209,669, filed on Aug. 1, 2002.

(51) Int. Cl. G06F 17/00

(52) U.S. Cl. 707/202; 707/100

(57) ABSTRACT

A computer-based system for requesting, assigning, monitoring, updating, and reporting on the status of the collateral recovery process for all of the participants includes a communications methodology for maintaining a series of remote databases and synchronizing the remote databases with a master database via a synchronization server. Additionally, a lien holder can access the computer-based system via a global computer network such as the Internet and request collateral repossession services and then track the request during the process. This includes the ability to monitor the date of recovery, the condition of the collateral upon recovery, and the ultimate disposition of the collateral after recovery. Similarly, the repossession agent can more quickly and efficiently receive recovery requests and provide updates to the lien holder without undue delay. Finally, the computer-based system preferably provides a series of web-based reports that allow all of the participants in the collateral recovery process full and complete access to various performance criteria and measurements. By tracking the performance of the various parties involved in the collateral recovery process, the best service providers can be identified, thereby enhancing the prospect for efficient collateral recovery and providing for more effective decision-making.

### RELATED APPLICATIONS

This application is a continuation in part of U.S. patent application Ser. No. 10/209,669, filed Aug. 1, 2002, which application is now pending at the United States Patent and Trademark Office, which application is incorporated herein by reference.

### BACKGROUND OF THE INVENTION

1. Technical Field

The present invention relates generally to the field of computerized data bases and more particularly to the use of computer-based systems and methods for tracking and recovering collateral such as motor vehicles and the like.

2. Background Art

Despite advances in computer technology and communications capability, a considerable amount of paper work is still required for certain companies that employ mobile field units, that is, mobile field agents that use cars and/or trucks to operate out of the main office or offices. In many operations, the main office will receive a request for services from a customer and will need to relay that request to one or more field agents. The request for services form is prepared, usually with manual steps, by personnel who are familiar with the customers, the business operation, and the field agents. After preparing the necessary paperwork, the request for services can be delivered to the appropriate field agent for processing.

This type of operation is found in many different industries, with the collateral recovery industry providing a particularly relevant example. In the collateral recovery business, a person will typically purchase an item of personal property, such as an automobile, motorcycle, boat, etc. and finance their purchase over time. In these cases, the lender will generally place a lien on the personal property and the personal property becomes a form of collateral to secure the loan. The lien holder also reserves the right to repossess the collateral if the purchaser fails to make the required payments or otherwise defaults on their obligation with respect to the collateral. In the case of default, it may be necessary for the lien holder to repossess the collateral in order to secure their interest in the collateral. In these cases, the lien holder will typically engage the services of a third party repossession agent and contract with the third party repossession agent to complete the repossession.

While the process described above is a frequently employed methodology for collateral recovery, it is not without certain drawbacks. For example, the manual paper-based processes typically utilized in the collateral recovery industry are very inefficient with many different forms and documents being handled by many different entities. Additionally, the communication channels employed to transmit the information related to the collateral from the lien holder to the repossession agent and back again are often facsimile transmissions, emails, and telephone calls. While these various communication methods are moderately effective, the lack of access to real-time information can be especially problematic in the case of collateral repossession because timely response in the case of default may mean the difference between successful collateral recovery and a lost investment for the lien holder.

Additionally, the lack of real-time or near real-time access to the repossession information may inadvertently lead to the improper or untimely repossession of a vehicle, thereby subjecting the lien holder to undesirable liability. This situation is the result of the rapidly changing status of many loan accounts. For example, a payment may have been received but not yet processed by the lien holder. If the vehicle is wrongfully repossessed, the lien holder may be liable and subject to penalties and/or fines.

Another problem with the presently employed collateral recovery systems is the lack of timely updates for the parties involved in the recovery process, including the lien holder and the repossession agent. The lien holder may request repossession and not be able to ascertain whether or not the request for repossession has been received and whether or not it is being actively pursued due to the inadequacy of the communication processes employed. Accordingly, even when the collateral has been successfully recovered, the lien holder may not be advised for an extended period of time, based on the availability of the communication systems being used by the parties. A delayed fax transmission or unreturned phone call may add days to the time the collateral can be transferred or sold by the lien holder. Finally, it is difficult if not impossible for the lien holders and the repossession agents to build, maintain, and access historical records related to the effectiveness of the repossession process with the desired efficiency. This means that ineffective relationships are often maintained by the sheer force of momentum, rather than by design.

As shown by the discussion herein, without additional improvements in the systems and methods utilized in the collateral recovery business, collateral repossession results will continue to be sub-optimal.

### SUMMARY OF THE INVENTION

The apparatus and methods of the present invention provide for the efficient and effective recovery of collateral by a third party agent for a lien holder. The most preferred embodiments of the present invention include a computer-based system for requesting, assigning, monitoring, updating, and reporting on the status of the collateral recovery process for all of the participants. The computer-based system includes a communications methodology for maintaining a series of geographically remote databases and synchronizing the geographically remote databases with a master database via a synchronization server.

Specifically, the lien holder can access the computer-based system via a global computer network such as the Internet and request a collateral repossession and then track the request during the process. This includes the ability to monitor the date of recovery, the condition of the collateral upon recovery, and the ultimate disposition of the collateral after recovery. Similarly, the repossession agent can more quickly and efficiently receive recovery requests and provide updates to the lien holder without undue delay.

The computer-based system preferably includes a master database for tracking collateral recovery information and the status of each collateral recovery request. Additionally, the master database communicates with a synchronization server that, in turn, communicates with a series of mobile databases. Each repossession agent will utilize a field vehicle that includes a wireless communication device and a mobile database for storing the information relative to the collateral recovery process for a given subset of collateral recovery requests. Given the nature of the collateral recovery industry, the geographically remote databases represent databases that may be separated from the master database and/or the synchronization server by distances in excess of one mile and limited only by the inherent limitations of the various communication devices used to communicate the collateral recovery service requests and status updates to the same.

Whenever the geographically remote database in the field vehicle is unable to communicate with the synchronization server, the collateral recovery information is stored and maintained in the remote database. Then, whenever the field vehicle is able to re-establish communication with the synchronization server, it communicates its updates to the synchronization server. Similarly, the synchronization server communicates updates from the master database to the mobile database. In this fashion, the master database and the mobile database are both regularly updated with the appropriate data.

Finally, a graphical user interface is provided for inputting, updating, and accessing the information stored in the master database. The interface provides access to a series of web-based reports that allow all of the participants in the collateral recovery process full and complete access to various performance criteria and measurements, within the permission and privacy constraints of the system. This interface provides valuable information that can be used for a variety of purposes. For example, by tracking the performance of the various parties involved in the collateral recovery process, a lien holder can select the best service providers, thereby enhancing the prospect for recovery and providing for more effective decision-making. Similarly, third party repossession agents can review and monitor the performance of their employees during the collateral recovery process.

### BRIEF DESCRIPTION OF THE DRAWINGS

The preferred embodiments of the present invention will hereinafter be described in conjunction with the appended wherein like designations denote like elements and:

FIG. 1 is an overall block diagram of a computer-based system for collateral recovery in accordance with a preferred embodiment of the present invention;

FIG. 2 is a block diagram of a computer for implementing the computer-based system for collateral recovery in FIG. 1 in accordance with a preferred embodiment of the present invention;

FIG. 3 is a schematic representation of a series of databases used to store and transmit data for the computer-based system for collateral recovery in FIG. 1 in accordance with a preferred embodiment of the present invention;

FIG. 4 a flowchart for a method of performing collateral recovery activities in accordance with a preferred embodiment of the present invention; and

FIG. 5 is a flowchart for a method of preparing reports using the system of FIG. 1 in accordance with a preferred exemplary embodiment of the present invention.

### DETAILED DESCRIPTION

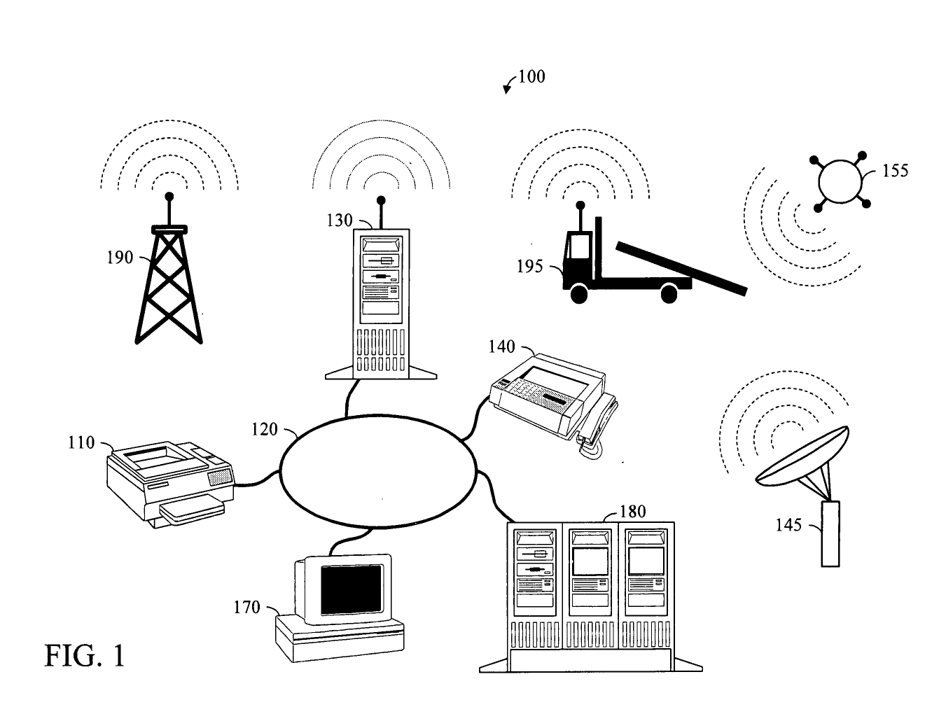

Referring now to FIG. 1, a block diagram of a computer-based system 100 for collateral recovery in accordance with a preferred embodiment of the present invention typically comprises: a synchronization server 130; a satellite transceiver 145; a satellite 155; a computer 170; a data server 180; a communication tower 190; and a field service vehicle 195, all coupled via a network 120. Additionally, an optional printer 110 and an optional fax machine 140 are shown. Taken together, computer-based system 100 provides a way for car dealers, lien holders (including financial institutions), third party collateral recovery agents and the like to more efficiently and effectively manage the collateral recovery process as described herein in conjunction with the various preferred embodiments of the present invention.

Optional printer 110 and an optional fax machine 140 are standard peripheral devices that may be used for transmitting or outputting paper-based collateral recovery documents, notes, financial transactions, reports, etc. in conjunction with the collateral recovery related queries and transactions processed by computer-based system 100. Optional printer 110 and optional fax machine 140 may be directly connected to network 120 or indirectly connected via any or all of computer systems 170 and/or data server 180. Finally, it should be noted that optional printer 110 and optional fax machine 140 are merely representative of the many types of peripherals that may be utilized in conjunction with computer-based system 100. It is anticipated that other similar peripheral devices will be deployed in the various preferred embodiment of the present invention and no such device is excluded by its omission in FIG. 1.

Network 120 is any suitable computer communication link or communication mechanism, including a hardwired connection, an internal or external bus, a connection for telephone access via a modem or high-speed T1 line, radio, infrared or other wireless communications, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 120 may suitably include a dial-up phone connection, broadcast cable transmission line, Digital Subscriber Line (DSL), ISDN line, or similar public utility-like access link.

In the most preferred embodiments of the present invention, at least a portion of network 120 comprises a standard wired or wireless Internet connection between the various components of computer-based system 100. Network 120 provides for communication between the various components of computer-based system 100 and allows for relevant information to be transmitted from device to device. In this fashion, a user of computer-based system 100 can quickly and easily gain access to the relevant data and information utilized to perform collateral recovery as described in conjunction with the various preferred embodiments of the present invention. Regardless of physical nature and topology, network 120 serves to logically link the physical components of computer-based system 100 together, regardless of their physical proximity. This is especially important because in many preferred embodiments of the present invention, synchronization server 130, data server 180, computer system 170 will be geographically remote and separated from each other.

In the most preferred embodiments of the present invention, network 120 also includes a connection to other networks, maintained by third party entities. For example, in the case of automobile repossession, network 120 may be connected to the electronic networks of various financial institutions. This level of interconnectivity allows for the more efficient processing of collateral recovery requests. The data for many lien holders is already stored in the various databases at the various financial institutions and, accordingly, may be transmitted directly from the financial institution to the repossession agent whenever a new request for collateral recovery services is initiated by the lien holder. Similarly, much of the data related to the collateral is also stored in these same databases, allowing for the almost instantaneous transmission of the collateral-related data to the appropriate location whenever a request for recovery services is initiated.

Synchronization server 130 represents a relatively powerful computer system that is made available to computer system 170 and data server 180 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with synchronization server 130. Synchronization server 130 may also be configured with various additional software components (not shown this FIG.) such as a database and database servers, web servers, firewalls, security software, and the like. The use of these various hardware and software components is well known to those skilled in the art. Given the relative advances in the state-of-the-art computer systems available today, it is anticipated that functions of synchronization server 130 may be provided by many standard, readily available data servers.

Depending on the desired size and relative power required for synchronization server 130, storage area network (SAN) technology may also be deployed in certain preferred embodiments of the present invention. Additionally, devices for creating and verifying digital signatures (i.e., electronic signature processing) may also be included. Additionally, depending on the scale of implementation, multiple synchronization servers 130 may be deployed using failure avoidance redundancy and load-balancing methodologies well known to those skilled in the art.

In general, synchronization server 130 acts as a communication and storage intermediary between a master database maintained on data server 180 and one or more mobile databases maintained at each field service vehicle 195. Whenever the communication link, service or capability that provides for communication between data server 180 and the mobile databases maintained at each field service vehicle 195 (i.e., transceiver 145, satellite 155, and communication tower 190) is unavailable, synchronization server 130 stores the appropriate updates for the collateral recovery transaction information for data server 180 and the mobile databases maintained at each field service vehicle 195 and updates each location once communication is restored. The database and associated storage system for synchronization server 130 can be similar to that of data server 180 and can effectively “mirror” the changes made to the databases of data server 180 and the mobile databases maintained at each field service vehicle 195.

A typical transaction may be represented by a request for information relative to an existing or new collateral recovery transaction or an information request regarding a specific set of circumstances for a new or existing collateral recovery transaction. The requested information may include queries relative to organizations and individuals seeking collateral recovery services as well as reports and other information regarding the actual or proposed collateral recovery transactions.

Satellite transceiver 145, satellite 155, and communication tower 190 are representative of any wireless communication infrastructure that may be suitably deployed for the various preferred embodiments of the present invention. This includes radio frequency (RF) communications facilities, wireless broadband signals, cellular telephone communications facilities, etc. Regardless of the actual implementation selected these communications facilities are employed to enable and facilitate communication between synchronization server 130 and field service vehicles 195.

Computer system 170 may be any type of computer system known to those skilled in the art that is capable of being configured for use with computer-based system 100 as described herein. This includes laptop computers, desktop computers, tablet computers, pen-based computers and the like. Computer system 170 is most preferably a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Additionally, handheld and palmtop devices are also specifically included within the description of devices that may be deployed as computer system 170. It should be noted that no specific operating system or hardware platform is excluded and it is anticipated that many different hardware and software platforms may be configured to create computer system 170. As previously explained in conjunction with data server 180, various hardware components and software components (not shown this FIG.) known to those skilled in the art may be used in conjunction with computer system 170. It should be noted that in the most preferred embodiments of the present invention, computer system 170 is linked to its own LAN or WAN and has access to its own data server (not shown this FIG.).

Data server 180 represents a relatively powerful computer system that is made available to computer system 170 and synchronization server 130 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 180. Data server 180 may also be configured with various additional software components (not shown this FIG.) such as database servers, web servers, firewalls, security software, and the like.

The use of these various hardware and software components is well known to those skilled in the art. Given the relative advances in the state-of-the-art computer systems available today, it is anticipated that functions of data server 180 may be provided by many standard, readily available data servers. Depending on the desired size and relative power required for data server 180, storage area network (SAN) technology may also be deployed in certain preferred embodiments of the present invention. Additionally, devices for creating and verifying digital signatures (i.e., electronic signature processing) may also be included.

In general, data server 180 processes requests for various transactions for computer system 170. A typical transaction may be represented by a request for information relative to an existing or new collateral recovery transaction or an information request regarding a specific set of circumstances for a new or existing collateral recovery transaction. The requested information may include queries relative to organizations and individuals seeking collateral recovery services as well as reports and other information regarding the actual or proposed collateral recovery transactions.

Field service vehicle 195 represents any mobile collateral recovery vehicle, such as a tow truck, suitable for performing collateral recovery services. Each field service vehicle 195 will be outfitted with a computer system and database for accessing and updating information relative to requested collateral recovery services. The computer utilized with each field service vehicle 195 will most preferably be a laptop computer with similar capabilities as computer system 170 described herein. Additionally, each field service vehicle 195 will be configured to communicate with synchronization server 130 by utilizing satellite transceiver 145 and/or satellite 155 and/or communication tower 190.

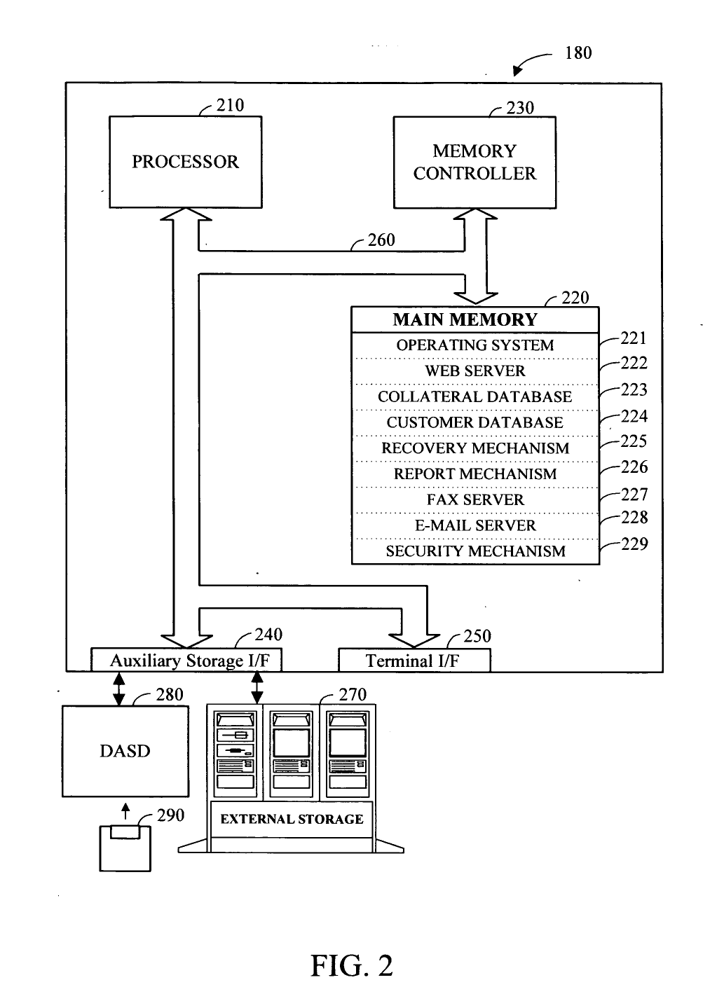

It should be noted that while FIG. 1 shows only a single computer system 170, it is anticipated that the most preferred embodiments of the present invention will comprise hundreds and even thousands of similarly configured computer systems 170 so as to provide access for many different entities. In the most preferred embodiments of the present invention, multiple computer systems 170 will all be configured to communicate with data server 180 and with each other via network 120. In addition, the most preferred embodiments of the present invention include an Application Service Provider (ASP) environment where data server 180 is operated as a clearinghouse in a hosted operation. In this fashion, multiple computer systems 170 will have access to data server 180 on a subscription or pay-for service basis. Data server 180 is further described below in conjunction with FIG. 2 below.

Those skilled in the art will recognize that the depiction of a single satellite transceiver 145, satellite 155 and communication tower 190 are merely representative of standard communication facilities in use today. In reality, multiple satellite transceivers 145, satellites 155 and communication towers 190 will be employed to facilitate “end-to-end” communications within computer-based system 100. Similarly, it is anticipated that a fleet of field service vehicles 195 will be deployed in the most preferred embodiments of the present invention.

By utilizing the various components of computer-based system 100, a request for collateral recovery services can be made by the operator of computer system 170, with the request being received and processed by data server 180. Data server 180 then communicates the request to synchronization server 130 which, in turn, communicates the request to field service vehicle 195. This communication will take place by utilizing network 120 and/or satellite 155 and/or communication tower 190, as necessary. Once the requested service has been accomplished by field service vehicle 195, notice of completion can be communicated to synchronization server 130 and then to data server 180 and, finally, back to the requester at computer system 170. Additionally, intermediate status reports and updates regarding the requested services can be transmitted from field service vehicle 195 to the requester of services in a similar fashion (via synchronization server 130 and data server 180).

Referring now to FIG. 2, a block diagram representing data server 180 of FIG. 1 for implementing the computer-based system for collateral recovery in FIG. 1 in accordance with a preferred embodiment of the present invention is depicted. A data server 180 in accordance with a preferred embodiment of the present invention is most preferably a relatively powerful computer system that is made available to computer system 170 and synchronization server 130 via network 120. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 180.

Data server 180 may also be configured with various additional software components (not shown this FIG.) such as database servers, web servers, firewalls, security software, and the like. The use of these various hardware and software components is well known to those skilled in the art. Given the relative advances in the state-of-the-art computer systems available today, it is anticipated that functions of data server 180 may be provided by many standard, readily available data servers. Depending on the desired size and relative power required for data server 180, storage area network (SAN) technology may also be deployed in certain preferred embodiments of the present invention. Additionally, devices for creating and verifying digital signatures (i.e., electronic signature processing) may also be included.

Data server 180 suitably comprises at least one Central Processing Unit (CPU) or processor 210, a main memory 220, a memory controller 230, an auxiliary storage interface 240, and a terminal interface 250, all of which are interconnected via a system bus 260. Note that various modifications, additions, or deletions may be made to data server 180 illustrated in FIG. 2 within the scope of the present invention such as the addition of cache memory or other peripheral devices. FIG. 2 is not intended to be an exhaustive example, but is presented to simply illustrate some of the salient features of data server 180.

Processor 210 performs computation and control functions of data server 180, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor. Processor 210 suitably executes one or more software programs contained within main memory 220.

Auxiliary storage interface 240 allows data server 180 to store and retrieve information from auxiliary storage devices, such as external storage mechanism 270, magnetic disk drives (e.g., hard disks or floppy diskettes) or optical storage devices (e.g., CD-ROM). One such suitable storage device is a direct access storage device (DASD) 280. As shown in FIG. 2, DASD 280 may be a floppy disk drive that may read programs and data from a floppy disk 290. It is important to note that while the present invention has been (and will continue to be) described in the context of a fully functional computer system, those skilled in the art will appreciate that the mechanisms (particularly recovery mechanism 225 and/or report mechanism 226 of FIG. 2) of the present invention are capable of being distributed in conjunction with signal bearing media as one or more program products in a variety of forms, and that the various preferred embodiments of the present invention applies equally regardless of the particular type or location of signal bearing media used to actually carry out the distribution. Examples of signal bearing media include: recordable type media such as floppy disks (e.g., disk 290) and CD ROMS, and transmission type media such as digital and analog communication links, including wireless communication links.

Memory controller 230, through use of an auxiliary processor (not shown) separate from processor 210, is responsible for moving requested information from main memory 220 and/or through auxiliary storage interface 240 to processor 210. While for the purposes of explanation, memory controller 230 is shown as a separate entity; those skilled in the art understand that, in practice, portions of the function provided by memory controller 230 may actually reside in the circuitry associated with processor 210, main memory 220, and/or auxiliary storage interface 240.

Terminal interface 250 allows users, system administrators and computer programmers to communicate with data server 180, normally through separate workstations or through stand-alone computer systems such as computer systems 170 of FIG. 1. Although data server 180 depicted in FIG. 2 contains only a single main processor 210 and a single system bus 260, it should be understood that the present invention applies equally to computer systems having multiple processors and multiple system buses. Similarly, although the system bus 260 of the preferred embodiment is a typical hardwired, multi-drop bus, any connection means that supports bi-directional communication in a computer-related environment could be used.

Main memory 220 suitably contains an operating system 221, a web server 222, collateral database 223, a customer database 224, a recovery mechanism 225, a report mechanism 226, a fax server 227, an e-mail server 228, and a security mechanism 229. The term “memory” as used herein refers to any storage location in the virtual memory space of data server 180.

It should be understood that main memory 220 may not necessarily contain all parts of all components shown. For example, portions of operating system 221 may be loaded into an instruction cache (not shown) for processor 210 to execute, while other files may well be stored on magnetic or optical disk storage devices (not shown). In addition, although collateral database 223, customer database 224, recovery mechanism 225, and report mechanism 226 are shown to reside in the same memory location as operating system 221, it is to be understood that main memory 220 may consist of multiple disparate memory locations. It should also be noted that any and all of the individual components shown in main memory 220 may be combined in various forms and distributed as a stand-alone program product. Finally, it should be noted that additional components, not shown in this figure may also be included.

For example, most preferred embodiments of the present invention will include a security and/or encryption mechanism 229 for verifying access to the data and information contained in and transmitted by data server 180. Security and/or encryption mechanism 229 may be incorporated into operating system 221 or recovery mechanism 225. Additionally, security mechanism 229 may also provide encryption capabilities for computer-based system 100 of FIG. 1, thereby enhancing the robustness of computer-based system 100. Once again, depending on the type and quantity of information stored in collateral database 223 and customer database 224, security mechanism 229 may provide different levels of security and/or encryption for different computer system 170 and data server 180. Additionally, the level and type of security measures applied by the security system may be determined by the nature of a given request and/or response. In some preferred embodiments of the present invention, the security system may be contained in or implemented in conjunction with certain hardware components (not shown this FIG.) such as hardware-based firewalls, switches, dongles, and the like.

Operating system 221 includes the software that is used to operate and control data server 180. In general, processor 210 typically executes operating system 221. Operating system 221 may be a single program or, alternatively, a collection of multiple programs that act in concert to perform the functions of an operating system. Any operating system known to those skilled in the art may be considered for inclusion with the various preferred embodiments of the present invention.

Web server 222 may be any web server application currently known or later developed for communicating with web clients over a network such as the Internet. Examples of suitable web servers 222 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 222 may be implemented as a cluster of multiple web servers, with separate hardware and software systems. This configuration provides additional robustness for system uptime and reliability purposes. Regardless of the specific form of implementation, Web server 222 provides access, including a user interface, to allow individuals and entities to interact with recovery mechanism 225 and report mechanism 226, including via network 120 of FIG. 1.

Collateral database 223 and customer database 224 are representative of any suitable database known to those skilled in the art. In the most preferred embodiments of the present invention, collateral database 223 and customer database 224 are Structured Query Language (SQL) compatible database files capable of storing information relative to the various collateral recovery programs, fees, costs, rates, third party repossession agencies or entities, including names, addresses, account preferences, etc. While collateral database 223 and customer database 224 are shown to be residing in main memory 220, it should be noted that collateral database 223 and customer database 224 may also be physically stored in a location other than main memory 220. For example, collateral database 223 and customer database 224 may be stored on external storage device 270 or DASD 280 and coupled to data server 180 via auxiliary storage I/F 240.

Collateral database 223 is used to store information about the specific collateral to be recovered. For example, in the case of automobile recovery, collateral database 223 would include information such as vehicle make, model, year, VIN, owner, known addresses associated with the collateral, etc. In the most preferred embodiments of the present invention, whenever a VIN is entered into collateral database 223, the VIN is checked against a universal or master VIN database (not shown this FIG.) to verify that the VIN entered in to database 223 is a valid VIN. Once the VIN has been verified, the vehicle data associated with the VIN (i.e., vehicle year, make and model) is automatically entered into collateral database 223 as well, thereby reducing the amount of manual data entry and reducing the possibility of human error.

Additionally, collateral database 223 is used to monitor and update the status of any recovery effort for any collateral identified in collateral database 223. This would include the date and time the request for recovery was made, the dates and times of attempted recovery, condition of the collateral, the recovery agent assigned to perform the recovery, ultimate success or failure of the recovery attempt, ultimate disposition of the collateral after recovery, etc.

Customer database 224 is used to store information about various customers (or users) that use system 100 of FIG. 1 to request and/or perform collateral recovery services. This would include information about the various lenders, lien holders, third party recovery agents, etc.

Recovery mechanism 225 is most preferably a web-based software application that provides a graphical user interface for requesting, monitoring, updating and reporting on various activities associated with the collateral recovery process. In the most preferred embodiments of the present invention, a user of computer system 170 of FIG. 1 will access recovery mechanism 225 via a standard web browser such as Safari, FireFox, Netscape, Internet Explorer, etc. By using recovery mechanism 225, the user will be able to request collateral recovery services, including selecting a third party collateral recovery agent. Recovery mechanism 225 will serve as the interface to database 223 and customer database 224 and will store, update and retrieve information in collateral database 223 and customer database 224.

The user interface of recovery mechanism 225 will provide a significant number of features to assist in the collateral recovery process. Each request for collateral recovery will be received by recovery mechanism 225 via email, fax, direct website entry via web server 222, or any other appropriate method known to those skilled in the art for receiving requests for service. Once a request is received, the information associated with the request is entered into collateral database 223 and/or customer database 224. The request will contain the information necessary to begin the collateral recovery process and the information can be entered automatically or manually, as necessary. For example, various text-to-data conversion methodologies can be used to extract data from a fax message and, by associating the appropriate areas of the fax with the appropriate fields in collateral database 223 and/or customer database 224.

Once the necessary information has been entered into the appropriate database(s), an “assignment” is generated. The assignment contains all of the information necessary for a third party collateral recovery agency to proceed with a collateral repossession effort. Each party that accesses system 100 of FIG. 1 will be provided with appropriate and limited access rights in conjunction with security mechanism 229. This allows the operators of system 100 of FIG. 1, the lien holder, and the third party collateral recovery agency to communicate more effectively and efficiently regarding any specific assignment while providing database access controls to safeguard the integrity and confidentiality of the data. Each new assignment can then be “dispatched” to the appropriate third party collateral recovery agent.

During the assignment creation process, if an identical assignment has been previously created and/or assigned (as verified by VIN, license plate, etc.), system 100 of FIG. 1 will notify the user that the assignment may already exist. This will provide the user with an opportunity to review the previously created assignment and determine if the current assignment is a duplicate of a current assignment. If so, the user may abandon the current data entry process and discard the source of the collateral recovery request (e-mail, fax sheet, web entry, etc.). If the assignment is a duplicate of a currently “Closed” assignment, the user may approve the current assignment entry and continue through completion. If the duplicate assignment is accepted, an electronic connection or “hyper-link” to the previous assignment will be added to the assignment overview screen. This gives the user the ability to quickly retrieve any information from the previously created assignment. This allows the user to save time and energy for collateral that may be the subject of multiple recovery requests.

During the assignment recovery process, various data components and the status identifiers associated with the data components and with each assignment in general can be viewed and updated by the various authorized users of the system 100 of FIG. 1. For example, each collateral recovery assignment generated by of system 100 of FIG. 1 will be identified by a status identifier that will provide an overview of that specific assignment. The most preferred embodiments of the present invention will use at least three main status identifiers to identify the status of a given assignment. These identifiers are most preferably “New,” “Active” and “Inactive.”

A “New” status indicator means that a valid assignment has been created and may now be assigned to a third party collateral recovery agent. Once a “New” assignment has been validated, the status may be updated to “Dispatch” and the assignment may be placed in a dispatch queue. This allows a user system 100 of FIG. 1 an opportunity to review each assignment prior to dispatch to an adjuster in the field. An “Active” status identifier means that the assignment is currently a valid assignment and has been assigned to a third party collateral recovery agent and the collateral is in the process of being recovered. An “Inactive” status identifier means that the assignment is valid, but is not being actively pursued at the present time.

“Inactive” status may be the result of many different factors, including sub-status indicators such as “Hold,” “Suspend,” “Recovered,” and/or “Closed.” “Hold” or “Suspend” status may be used to inactivate a collateral recovery assignment while new information is being collected or, to reflect the fact that a payment has been made to the lien holder. “Recovered” status is used to indicate that the collateral recovery process has been completed and that the desired post-recovery procedures associated with the assignment are underway. “Closed” status will be used to indicate an assignment where collateral recovery was not successful and when no further attempts will be made. Overview grids and how they help with the management of assignments.

Each of the assignments, along with the corresponding status of the assignment, may be viewed by a user of system 100 of FIG. 1 by accessing a series of tabs in the user interface of recovery mechanism 225. Those skilled in the art will be familiar with the use of tabs in a graphical user interface, such as a web browser interface, for the purpose of grouping related data to facilitate viewing by the user. Each of the assignments in system 100 of FIG. 1 may identified by its status and viewed under separate status tabs within the assignment overview screen of the user interface.

This is also true for pre-recovery and post-recovery assignments inasmuch as there is a status identifier associated with each assignment. This feature allows the data to be presented in a very intuitive manner to the user by allowing the user to see all assignments of a particular status in a single view, and to quickly switch from view to view. Appropriate security features such as user IDs and passwords will be provided by security mechanism 229 to allow the presentation of assignment information only for the users authorized to view a given assignment.

In this fashion, a lien holder may access the web-based graphical user interface of recovery mechanism 225 and view all assignments associated with that lien holder presently contained in collateral database 223, grouped by status. Similarly, a third party collateral recovery agent may access the web-based graphical user interface of recovery mechanism 225 and view all assignments presently contained in collateral database 223, grouped by status for that specific third party collateral recovery agent. This functionality will also provide a mechanism for a third party collateral recovery agent with multiple physical locations to access any combination of assignments for any location or locations from a single user interface.

In addition to status identifiers for each individual assignment as a whole, status identifiers may also be provided for many of the various individual data components that comprise each assignment in order to provide relevant feedback for the user of system 100 of FIG. 1. For example, each new assignment will contain a last known address for the debtor or owner of the collateral and, whenever a new address is first input, it will typically be automatically assigned a default status identifier of “valid.” Later, if some user of system 100 of FIG. 1 becomes aware that an address is invalid, they can change the address status identifier to “invalid.” Those skilled in the art will recognize that report mechanism 226 can use the various status identifiers to sort and otherwise order the various assignments to provide responses to inquiries that may be made by the various users of system 100 of FIG. 1.

For example, a report could be generated that would show all presently “Active” assignments. Alternatively, all assignments with a status indicator of “Recovered” could be reviewed, along with pertinent data such as recovery date, third party recovery agent, condition of the collateral upon recovery, etc. Additionally, a “run list” could be generated by a third party collateral recovery agent whereby all of their “Active” assignments are prioritized and reported by some factor (by collateral value, by amount outstanding on the loan, by city, by zip code, etc.) so that an effective and efficient collateral recovery operation can be completed.

Another report may be generated to show all “New” or “Active” status assignments that have not had any type of an update within some user-definable period of time, such as 72 hours. This will allow the users of system 100 of FIG. 1 to identify potential problems with any given collateral recovery effort before too much time elapses.

E-mail server 228 can be used in conjunction with recovery mechanism 225 to provide an “auto notification” function for the users of system 100 of FIG. 1. In this embodiment of the present invention, any change in the status of an assignment, along with the reason for the change in the status of the assignment, can be automatically sent to the appropriate users of system 100 of FIG. 1. For example, whenever an assignment has been dispatched or assigned to a third party collateral recovery agent, e-mail server 228 may be configured to send an e-mail message to the lien holder, alerting the lien holder that the assignment has been made and identifying the third party collateral recovery agent that will be attempting the collateral recovery effort.

As the collateral recovery process continues, additional e-mail notices can be generate by e-mail server 228 to keep all authorized and interested parties updated as to the status of the collateral recovery process. Additional post-recovery activities may also be used to drive updates by e-mail server 228. For example, after the collateral has been recovered, it may be sold to satisfy some or all of the outstanding debt owed to the lien holder. In that case, the collateral storage and sales events, along with the associated costs/profits/losses, may be used to trigger and e-mail message to be sent by e-mail server 228 to the appropriate parties.

To facilitate the collateral recovery process, each address for collateral entered into collateral recovery database 223 may be converted to GPS coordinates and the GPS coordinates may be made available to the third party collateral recovery agents. In the most preferred embodiments of the present invention, the GPS coordinates may be used by the operator of field service vehicle 195 in conjunction with an electronic map to provide a visual indication of the address for recovery of the collateral. This will assist the operator of field service vehicle 195 to more quickly and efficiently recover the collateral.

Finally, the user interface associated with recovery mechanism 225 will include a “History” tab. The History tab is simply a system generated location or web page that provides a complete historical record of the activities and actions associated with each assignment generated by system 100 of FIG. 1. This could include items such as emails sent and received by e-mail server 228, status changes, debtor name edits, VIN/Model #/serial # edits, collateral description edits, assignment type change, user generated notes, transfers, lien holder contact and address changes, payment history, invoices, mileage to recover the collateral, etc. Those skilled in the art will recognize that this list is merely illustrative and not exhaustive. Many other historical items can and will be tracked in the various preferred embodiments of the present invention. Basically, any information received by system 100 of FIG. 1 relative to a given assignment may be stored and presented in conjunction with the “History” tab.

It is anticipated that reports related to performance measurements for effectiveness and efficiency of the collateral recovery process will be most valuable. A series of “report cards” will be generated to evaluate and score the performance of each individual or entity that participates in the collateral recovery process. All of the participants will be able to evaluate the performance of the other participants, thereby establishing a series of performance criteria and benchmarks for measurement.

Additionally, recovery mechanism 225 will be configured to transmit and receive messages for transmission to one or more users of system 100 of FIG. 1. Any desired update or notice can be sent to any user of system as an urgent message. For example, if, during the collateral recovery process, the collateral is lost or stolen, an urgent message can be transmitted by the field agent to their home office and/or the lien holder. The message recipient is immediately notified of the urgent message and can access the urgent message interface to view the message for response or action. Only the designated recipient of a message can process and remove the message from his/her message interface. The system messages are date and time stamped at the time of inception as well as the time of delivery. Similarly, once the message has been accessed by the recipient, an additional date/time stamp is entered into the system for verification of message receipt.

In addition to the messaging system described above, any note or update provided by a user of system 100 of FIG. 1 may be designated as a confidential or “private” entry. In this fashion, any confidential note/update can be made available and accessed only by the designated user. To accomplish this confidential delivery, recovery mechanism 225 will coordinate access via security mechanism 229 to monitor and verify the appropriate levels of authorization for accessing the confidential notes and/or updates.

Report mechanism 226 is provided to allow a user of system 100 of FIG. 1 to create a variety of reports by accessing collateral database 223 and customer database 224. These reports will include status reports that highlight the status of completion for any collateral recovery request, the number and type of collateral recovery requests made, the timing of recovery completions, the third party agent assigned to complete the collateral recovery, etc. Those skilled in the art will recognize that the number and variety of reports that can be created and provided by report mechanism 226 is virtually unlimited and will be determined by the type and amount of data stored in collateral database 223 and customer database 224.

Those skilled in the art will recognize that although recovery mechanism 225 and report mechanism 226 are shown as separate entities in FIG. 2, recovery mechanism 225 and report mechanism 226 may be combined into a single software program or application. Additionally, collateral database 223 and customer database 224 may also be included in this software program or application.

Fax server 227 is any fax server known to those skilled in the art and is configured to receive inbound fax messages and to transmit outbound fax messages. Fax server 227 may format and transmit any data processed by computer-based system 100 of FIG. 1 and make it available for use by any other component of computer-based system 100 of FIG. 1. Additionally, fax server 227 may process the data received and send it directly to recovery mechanism 225 and make the incoming data for further processing by computer-based system 100, including processing by report mechanism 226.

While not required, the most preferred embodiments of data server 180 of FIG. 2 will typically include an e-mail server 228. E-mail server 228 is any e-mail server application capable of being configured and used to send and receive various status messages and updates to data server 180 and/or computer 170 of FIG. 1 via e-mail, as may be necessary to enhance the overall process of completing various collateral recovery transactions as described herein. This includes the generation of automated e-mail messages relating to the status of collateral recovery transactions performed in accordance with the various preferred embodiments of the present invention.

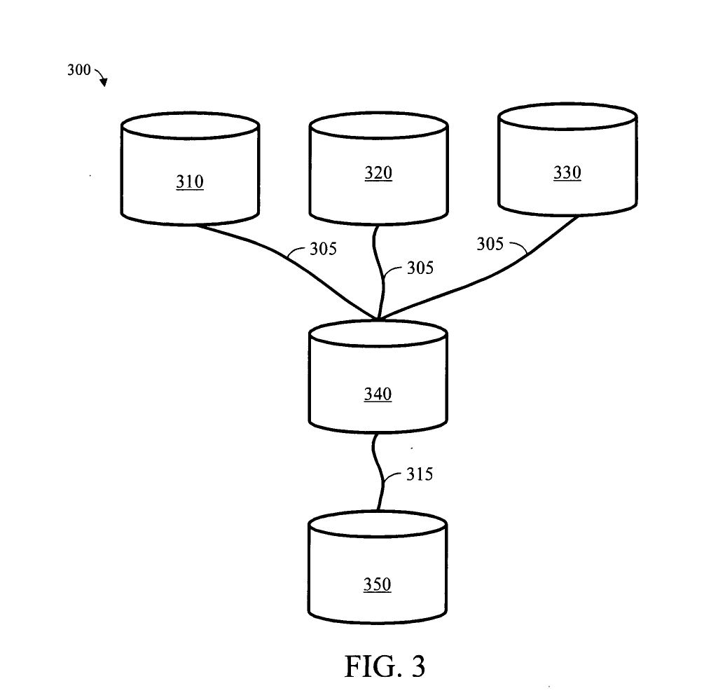

Referring now to FIG. 3, a schematic representation 300 of a series of databases used to store and transmit data for the computer-based system for collateral recovery in FIG. 1 in accordance with a preferred embodiment of the present invention is depicted. As shown in FIG. 3, a plurality of mobile databases 310, 320, and 330 are all connected and configured to communicate with a synchronization database 340 via communication link 305. Synchronization database 340 is similarly configured to communicate with master database 350 via communication link 315.

In the most preferred embodiments of the present invention, communication link 305 is a wireless communication link implemented via a wireless modem, cellular phone technology, satellite link, or the like. Any suitable wireless communication service capable of transmitting computer data from one location to another may be employed and no such communication service is excluded by it omission in this specification.

Communication 315 may be any communication service known to those skilled in the art for connecting multiple databases for communication purposes. This may be implemented as any suitable computer communication link or communication mechanism, including a hardwired connection, an internal or external bus, a connection for telephone access via a modem or high-speed T1 line, radio, infrared or other wireless communications, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future.

It should be noted that portions of communication link 315 may suitably include a dial-up phone connection, broadcast cable transmission line, Digital Subscriber Line (DSL), ISDN line, or similar public utility-like access link. In the most preferred embodiments of the present invention, communication link 315 is a hard-wired link implemented via CAT-5 cable, fiber optic cable, or the like. The hard-wired connection is preferred for purposes of stability, security, and transmission speed. However, those skilled in the art will recognize that communication link 315 may implemented in many different ways, utilizing a wide variety of technologies.

This configuration, including the use of synchronization database 340, allows various requests to be transmitted between the various databases depicted in FIG. 3, even when communication services are temporarily disrupted. This is especially important in wireless environments and for geographically remote areas without appropriate wireless facilities. The use of synchronization server 130 of FIG. 1, in conjunction with synchronization database 340, will allow the necessary data to be stored during periods of non-communication and then forwarded to the appropriate destination once communication is restored. In this fashion, a collateral recovery record (containing all necessary data for performing collateral recovery) can be synchronized and updated between mobile databases 310, 320, and 330, synchronization database 340, and master database 350. In a typical embodiment, synchronization database 340 may reside at synchronization server 130 of FIG. 1.

In the most preferred embodiments of the present invention, mobile databases 310, 320, and 330 are all contained in or other communicatively associated with one or more mobile computing devices such as laptop computers or handheld personal digital assistants (PDAs) or the like. In this case, the field agent will enter various data regarding the collateral recovery effort into their respective mobile databases 310, 320, and 330 by accessing the user interface for their mobile computing device. The mobile computing devices will all be configured to transmit the data entered by the field agents from mobile databases 310, 320, and 330 to synchronization database 340. Similarly, the mobile computing devices will be configured to receive data from database 340 and update mobile databases 310, 320, and 330 as appropriate.

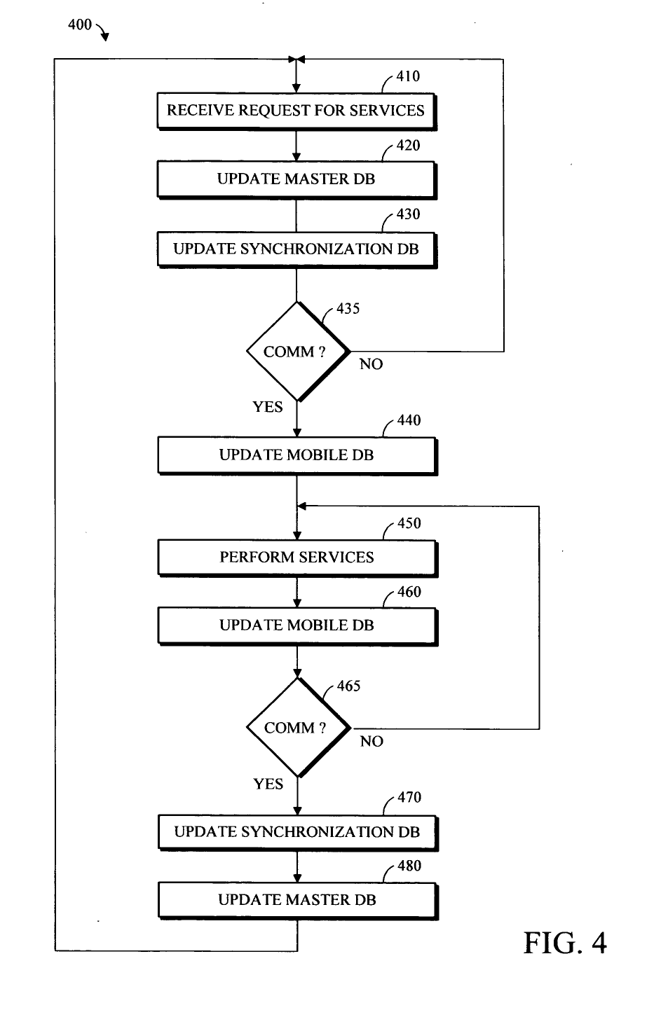

Referring now to FIG. 4, a flowchart for a method 400 of performing collateral recovery activities in accordance with a preferred embodiment of the present invention is depicted. As shown in FIG. 4, method 400 begins whenever a request for service is received (step 410). The request for service, in the case of an automobile repossession scenario, will typically be initiated by a lien holder making an initial assignment to a repossession agent for a delinquent loan payment. In the process, a facsimile transmission with a request and authorization for repossession will be transmitted to and received by the repossession agent. For most repossession agents, the incoming fax will be handled by fax server 227, as described in conjunction with FIG. 2. The incoming assignments are typically stored in a fax queue and held for data entry personnel to create a new repossession assignment, add any required supporting documentation or depending on the specific practices of the repossession agent, routed in some other fashion to create a database record for the new repossession request. In conjunction with the receipt and processing of the new request for services, an e-mail message may be sent by e-mail server 228 of FIG. 2 to the other parties involved with the collateral, notifying them of the initiation of the request for services.

All new repossession assignment requests are received and displayed for data entry. If multiple assignments are received in the same fax job the data entry clerk may split the incoming fax job into separate faxes for data entry purposes and multiple data entry clerks may simultaneously process multiple requests for service from multiple disparate lien holders. Those skilled in the art will recognize that fax input is a commonly employed technology for receiving information but other, more efficient methods are also available. For example, in the most preferred embodiments of the present invention, all new requests for service (and associated collateral information) will be entered by the lien holder and transmitted directly to and entered into the appropriate database at data server 180 of FIG. 2.

Once created, the request for service is stored in a master database (DB) (step 420) along with the relevant information for completing the request, as optionally entered by the data entry clerks. In the case of a typical collateral recovery request, this information will include the lien holder name and address, the defaulting party name and address, the description of the collateral (for an automobile recovery, this would include make, model, VIN, etc.), and other similar types of information that may be useful in the collateral recovery process. It should be noted that the master database described herein may be configured as a combination of the various databases described in conjunction with main memory 220 of FIG. 2.

Once entered into the master DB, the request for service can be transmitted to the synchronization server and the synchronization server DB is updated with the information necessary to fulfill the request for services (step 430). The synchronization server is capable of tracking the request for services and maintaining the integrity of the data as the request for services is processed and fulfilled. Given that the synchronization database associated with the synchronization server maintains only record updates, it may be significantly smaller than the master database and the mobile database. Additionally, in the most preferred embodiments of the present invention, each mobile database contains only the collateral recovery records assigned to a specific field vehicle. Accordingly, each mobile database may be significantly smaller than the master database.

Once the request for services has been transmitted to the synchronization server, the communication link between the synchronization server and mobile field units can be accessed. Each mobile field unit will be provided with a mobile DB that is capable of storing the information associated with any given request for service. Provided that the communication service between the synchronization server and the mobile field unit is active (step 435=“YES”), then the request for service can be transmitted to mobile DB that is collocated with the desired mobile field unit for processing.

If the communication service between the synchronization server and the mobile is not active (step 435=“NO”), then the request for service will not be transmitted to mobile DB until such time as the communication service becomes available for use. The synchronization DB can use any method known to those skilled in the art to periodically attempt to contact and synchronize the request for service(s) with the mobile DB. Until such time as a request for service is successfully transferred to the mobile DB, additional requests for service may be entered into the master DB and transferred to the synchronization DB as previously discussed.

Eventually, when the communication service becomes available (step 435=“YES”), the request for service and associated information will be stored in the mobile DB (step 440), thereby providing the operator of the mobile field unit with the information necessary to perform the requested service (step 450).

Once the services have been completed (whether successful or not), the status and the outcome of the activity are entered into the mobile DB (step 460). Then, as previously discussed, if the communication service between the synchronization server and the mobile field unit is active (step 465=“YES”), then the results of performing the requested service can be transmitted from mobile DB and synchronized with the synchronization server (step 470) and then, in turn, used to update the appropriate records in the master DB (step 480).

If, after performing the requested service, the communication service is not available (step 465=“NO”), then the information is kept in the mobile DB until such time as the communication service becomes available. By using the methodology presented herein, each request for service may be transmitted and performed, with appropriate updates also being transmitted, whenever the communication service is available. The synchronization server acts as an on-line buffer, tracking the request for service and updating both the master DB and the mobile DB. Those skilled in the art will recognize that multiple synchronization servers and multiple mobile DBs may be similarly deployed and the system allows for rapid and almost unlimited scaling.

Once the recovery of the collateral has been completed (step 450), notification of the completed recovery is part of the information that is updated in the mobile DB (step 460). Once this completion data has been transmitted to the master DB (steps 470 and 480), the completion data can be used to interface to an accounts payable module or accounting system. In this fashion, the duly authorized users of system 100 of FIG. 1 can create invoices and/or paycards for collateral recovery services performed.

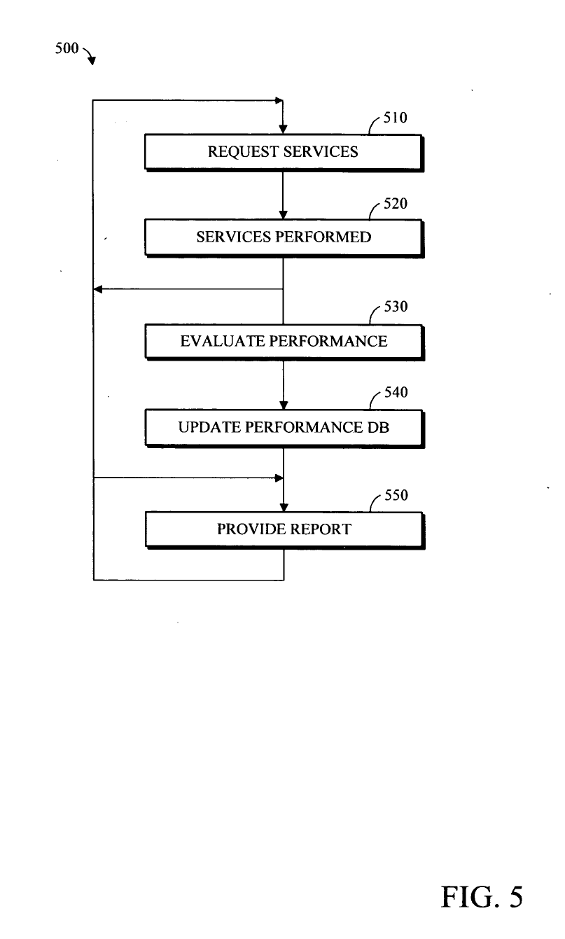

Referring now to FIG. 5, a method 500 for generating one or more reports using the system of FIG. 1 in accordance with a preferred exemplary embodiment of the present invention is depicted. As shown in FIG. 5, a request for services is received (step 510) and then performed (step 520). Once performed, the performance of the party or parties involved in the performance of the services can be evaluated (step 530) and the results of the evaluation will be used to update the performance database (DB) (step 540). Then, whenever desired, various reports can be constructed from the performance DB and provide for decision-making purposes (step 550). The performance DB may be implemented as part of the collateral DB shown in FIG. 2. Lot management—The user has the option to deliver unit to the auction immediately after recovery or place the unit in lot inventory.

One of the most significant aspects of the database interaction provided by the present invention is found in the post-recovery aspect of the reporting system. For example, the post recovery process for vehicle repossession includes the ability to more efficiently and effectively track and manage the collateral after recovery to the point of ultimate disposition. For most lien holders, it is very important to liquidate the collateral in a quick and efficient manner and to receive a reasonable amount of money at the time of disposition. If the collateral is not disposed of quickly enough, the lien holder may lose additional leverage in the market and be exposed to value reduction through incidental damage to the collateral or theft, etc.

Additionally, various asset recovery reports can be compiled by using the data entered by an insurance adjuster during the post-recovery process. The use of system 100 of FIG. 1 by the adjuster allows the adjuster to enter recovery data associated with the collateral recovery event such as recovery address, police agency notified, basic vehicle condition, etc. When the corresponding asset recovery information is saved in collateral database 223 of system 100 of FIG. 1, an automatic email or fax notification can be sent to the lien holder representative by e-mail server 228 or fax server 227. This process greatly reduces the reporting time of repossessions.

The various reports provided by report mechanism 226 of FIG. 2 allow the lien holder to track the collateral regardless of location and manage the collateral disposition process throughout. Given this information the client can make better decisions about how to dispose of the collateral. For example, the lien holder can identify how long it takes various repossession agents to recover the collateral and how long it takes to assess and report the condition of the collateral. Similarly, the lien holder can evaluate how much return on the disposition of the collateral is achieved by various repossession agents, thereby identifying the top performers. This will allow the lien holder to make appropriate business decisions as to which business partners should complete future repossession requests.

Many of the reports generated by report mechanism 226 of FIG. 2 are automatically generated based on circumstances and system related measurements. This includes information such as when the request for services was received and when the request was processed, etc. However, some reports are derived completely or substantially from the information entered by the field agents performing the collateral recovery. For example, an asset delivery form generated by recovery mechanism 226 and made available to the field agent allows the field agent to enter in the time of collateral recovery as well as the time of collateral delivery to the destination during the post-recovery process. This information allows the lien holder to verify delivery of the collateral to the location of ultimate disposition (auction, etc.) or to verify the actual recovery of the collateral. As previously explained, each of these activities may be used to trigger the transmission of an e-mail update by e-mail server 228 of FIG. 2.

Similarly, at the time of collateral recovery, the field agent can take an inventory of the any personal property left in the vehicle and create a personal property report. This personal property report can then be used to track the return of the personal property to the owner of the collateral, thereby reducing or minimizing the lien holder's liability or exposure for accidental loss or theft of personal property. Additionally, adjuster's reports, collateral condition reports, disposition reports, status reports, etc. are other examples of the many types of reports that can be generated using method 500 of FIG. 5 in conjunction with system 100 of FIG. 1. Those skilled in the art will recognize that these various reports are only representative samples of the types of reports that can be generated using the information entered into the system by the users of the system.

Additionally, certain system generated reports will also be available for creation and review. For example, since nature of each activity, the time of each database entry, and identity of each person making an entry in the database is recorded, a vast array of information is now available. The amount of time that lapsed from the time the order for services was placed until a recovery or other resolution was achieved can be measured and reported. This will help a lien holder to evaluate the responsiveness and overall performance of the third party collateral recovery agents and their respective organizations.

Similarly, a lien holder can track the ultimate disposition of the repossessed collateral to determine the most lucrative method and channel for liquidating the recovered collateral. In combination, the report capability of the present invention will lead to better decision making as well as more efficient business operations for those companies and individuals that incorporate the apparatus and methods set forth herein. Finally, it should be noted that all of the reports generated by report mechanism 226 of FIG. 2 may be viewed via a web browser interface or printed out in hard copy form using printer 110 of FIG. 1. Additionally, any report that can be created by report mechanism 226 of FIG. 2 can be e-mailed or faxed to one or more recipients by utilizing fax server 227 and/or e-mail server 228 of FIG. 2.

In summary, the present invention provides an apparatus and method for the broad application of a unique business process for collateral recovery where various entities including lender, lien holders, insurance companies, brokers, attorneys and the like are all benefited and served by the methods and integrated processes comprehended by the various preferred embodiments of the present invention. Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing the preferred exemplary embodiments of the present invention. Accordingly, it should be understood that various changes may be made in the function and arrangement of elements described in the various preferred exemplary embodiments without departing from the spirit and scope of the present invention as set forth in the appended claims.

1. An apparatus comprising:
at least one mobile database;
at least one synchronization database;
at least one processor;
a memory coupled to said at least one processor;
at least one master database residing in said memory; and
a recovery mechanism residing in said memory, said recovery mechanism synchronizing at least one collateral recovery record in said at least master database with said at least one synchronization database, said recovery mechanism synchronizing said at least one collateral recovery record with said at least one mobile database.

2. The apparatus of claim 1 wherein said at least one master database comprises:
a collateral database, said collateral database comprising a plurality of collateral recovery records describing a plurality of items used as collateral to secure a plurality of loans; and
a customer database, said customer database comprising a plurality of records describing a plurality of customers for said plurality of items used as collateral to secure a plurality of loans.

3. The apparatus of claim 1 further comprising a fax server mechanism residing in said memory.

4. The apparatus of claim 1 further comprising a report mechanism residing in said memory, said report mechanism providing a user interface for evaluating at least one collateral recovery related service and for creating at least one report related to said at least one collateral recovery related service.

5. The apparatus of claim 1 further comprising an e-mail server residing in said memory, said e-mail server transmitting at least one e-mail message containing information extracted from said at least one master database.

6. The apparatus of claim 1 further comprising a network coupled to said at least one processor.

7. The apparatus of claim 1 further comprising at least one wireless communication device, said at least one wireless communication device transmitting said at least one collateral recovery record to said at least one mobile database.

8. The apparatus of claim 1 further comprising a security mechanism residing in said memory, said security mechanism providing security and encryption services in conjunction with synchronizing said at least one collateral recovery record.

9. An apparatus for enhancing collateral recovery comprising:
at least one processor;
a memory coupled to said at least one processor;
a master database residing in said memory;
a synchronization database communicatively coupled to said master database;
a geographically remote mobile database communicatively coupled to said master database;
at least one collateral recovery record stored in said master database, said at least one collateral recovery record including data pertaining to at least one item used as collateral to secure a loan;
at least one wireless communication link communicatively and selectively coupled to said synchronization database and said mobile database;
a recovery mechanism residing in said memory, said recovery mechanism monitoring said at least one wireless communication link and periodically communicating at least one update for said at least one collateral recovery record between said synchronization database and said mobile database based on said monitoring of said at least one wireless communication link; and
a security mechanism residing in said memory, said security mechanism providing security and encryption services in conjunction with said periodically communicating said at least one update for said at least one collateral recovery record between said synchronization database and said mobile database.

10. A method comprising the steps of:
a) receiving a request for collateral recovery services;
b) updating a master database to reflect said request for collateral recovery services;
c) updating a synchronization database to reflect said request for collateral recovery services;
d) verifying a wireless communication link between said synchronization database and a mobile database;
e) updating said mobile database to include said request for collateral recovery services if said wireless communication link has been verified;
f) storing said request for collateral recovery services in said synchronization database if said wireless communication link is not verified; and
g) repeating steps d) and e) and f) until said wireless communication link has been verified and said mobile database has been updated to reflect said request for collateral recovery services.

11. The method of claim 10 further comprising the step of reporting on at least one performance criteria related to said request for collateral recovery services.

12. The method of claim 10 further comprising the steps of:
h) entering an update into said mobile database to reflect the completion of said collateral recovery services;
i) verifying a wireless communication link between said synchronization database and said mobile database;
j) updating said synchronization database to reflect said completion of said collateral recovery services if said wireless communication link has been verified;
k) updating said master database to reflect said completion of said collateral recovery services;
l) storing said update to reflect completion of said collateral recovery services in said synchronization database if said wireless communication link is not verified; and
m) repeating steps i) and j) and k) until said wireless communication link has been verified and said master database has been updated to reflect completion of said collateral recovery services.

13. The method of claim 11 wherein said step of entering an update into said mobile database to reflect the completion of said collateral recovery services comprises the step of accessing a recovery mechanism via a web server.

14. The method of claim 10 further comprising the steps of:
performing a collateral recovery process by synchronizing a plurality of updates to a plurality of collateral recovery services requests in said master database, said synchronization database, and said mobile database via a network, a portion of said network comprising said wireless communication link;
evaluating a plurality of performance characteristics for a plurality of participants in said collateral recovery process using a plurality of collateral recovery performance criteria, thereby creating an evaluation; and
ranking said plurality of participants in said collateral recovery process based on said evaluation.

15. The method of claim 14 wherein said step of evaluating a plurality of performance characteristics for a plurality of participants in said collateral recovery process using a plurality of collateral recovery performance criteria, thereby creating an evaluation is accomplished via accessing a web-based software application via a standard web browser.

16. A program product comprising:
a recovery mechanism, said recovery mechanism being configured to synchronize at least one collateral recovery record between at least one master database, at least one synchronization database, and at least one mobile database; and
signal bearing media bearing said predictive mechanism.

17. The program product of claim 16 wherein said signal bearing media comprises recordable media.

18. The program product of claim 16 wherein said signal bearing media comprises transmission media.

19. The program product of claim 16 wherein said recovery mechanism is configured to communicate with at least one wireless communication device to synchronize said at least one collateral recovery record between said at least one master database, said at least one synchronization database, and said at least one mobile database.

20. The program product of claim 16 further comprising a web server, said web server being configured to provide a graphical user interface to access said at least one collateral recovery record.
